(19) United States
(12) Patent Application Publication
(10) Pub. No.: US 2025/0051165 A1
(43) Pub. Date: Feb. 13, 2025

(54) PREPARATION METHOD FOR IRON PHOSPHATE AND PREPARATION METHOD FOR LITHIUM IRON PHOSPHATE

(71) Applicant: HUBEI YUHAO HIGH-TECH NEW MATERIAL CO., LTD., Hubei (CN)

(72) Inventor: Qin WANG, Shiyan (CN)

(21) Appl. No.: 18/723,916

(22) PCT Filed: Nov. 30, 2022
(86) PCT No.: PCT/CN2022/135562

§ 371 Date: Jun. 25, 2024

(30) Foreign Application Priority Data
Mar. 30, 2022 (CN) 202210328818.0

(51) Int. Cl. C01B 25/37; B22F 9/24; C01G 3/10; C01G 51/10

(52) U.S. Cl. CPC C01B 25/375; C01G 3/10; C01G 51/10; B22F 9/24; C01P 2004/03; C01P 2004/52; C01P 2006/12; C01P 2006/80

(57) ABSTRACT

In one aspect, a preparation method of iron phosphate includes: mixing pyrite cinder and an sulfite evenly in water to obtain a first mixed system; adding phosphoric acid and a buffer to the first mixed system to perform a leaching reaction; performing a first solid-liquid separation on a slurry obtained from the leaching reaction to obtain a first filtrate and a first residue; introducing air into the first filtrate and then performing a first stirring reaction on the first filtrate; performing a second solid-liquid separation on a slurry obtained from the first stirring reaction to obtain a second filtrate and a second residue; and calcining the second residue to obtain iron phosphate.

This application is a U.S. national phase application under 35 U.S.C. § 371 based upon international patent application No. PCT/CN2022/135562 filed on Nov. 30, 2022, which itself claims priority to Chinese patent application No. 202210328818.0, filed on Mar. 30, 2022 at China National Intellectual Property Administration, and titled “PREPARATION METHOD FOR IRON PHOSPHATE AND PREPARATION METHOD FOR LITHIUM IRON PHOSPHATE”, the content of which is hereby incorporated herein in its entirety by reference.

### TECHNICAL FIELD

The present invention belongs to the field of battery technology, and in particular relates to a preparation method of iron phosphate and a preparation method of lithium iron phosphate.

### BACKGROUND

Pyrite cinder has been used as a raw material for iron smelting for more than 100 years. The amount of pyrite cinder discharged every year can reach more than 3 million tons, of which only more than 1 million tons have been properly utilized, and the rest is discharged into the environment. If accumulated, it will occupy farmland and pollute the soil; if discharged into rivers, it will pollute water bodies.

Currently, there are many methods for comprehensive utilization of pyrite cinder, and most of the pyrite cinder is used for “making bricks with iron concentrate sorting residue”. As raw material for iron smelting, pyrite cinder with an iron content of no less than 25% has certain economic value through sorting of iron concentrate from it. Its sorting process is not much different from the general iron ore sorting process. Gravity sorting or magnetic sorting can be used according to the specific magnetization coefficient of iron minerals in the pyrite cinder. The economic analysis is as follows: if the annual pyrite cinder sorting amount is 20,000 tons, assuming that ion concentrate with an iron content of 60% is sorted from the pyrite cinder with an iron content of 30% (as the iron concentrate with an iron content≥60% can be directly used for iron smelting), according to the calculation based on a yield of 40%, it can produce 8,000 tons of iron concentrate annually. The price of the ion concentrate with an iron content of 60% (sulfur content≤0.5) is 110 yuan per ton, the production cost is 70 yuan per ton, the profit per ton is 40 yuan, and the annual profit is 320,000 yuan. The total investment in building an iron sorting workshop is about 500,000 yuan, and the investment can be fully recovered within two years of production. After sorting the iron concentrate, there are still 12,000 tons of residue left, which can be used to make bricks. Pyrite cinder itself has no cementing ability, but it contains active substances such as SiO₂ and Al₂O₃.

Pyrite cinder can be used as a raw material for sintering, mainly utilizing its iron content to reduce the production cost of sintering raw materials. However, pyrite cinder has poor balling characteristics and high water absorption, which affects sintering productivity. In addition, it contains high sulfur content and harmful elements such as Cu, Pb and Zn, which affect the quality of the sintered material. The addition rate of pyrite cinder in sintering materials is generally less than 10%. Processing to increase its fineness and iron content and reduce its sulfur content allows pyrite cinder to be used as a raw material for pelletizing. Some prior arts employ a high-temperature chlorination process to chloride the metals contained in pyrite cinder, followed by hydrometallurgy to extract precious metals such as gold and silver, while removing harmful metals from the pyrite cinder.

With the development of lithium iron phosphate, cheap iron sources have become the focus of attention. The price of ferrous sulfate crystals, a by-product of titanium dioxide, has been steadily rising, reaching approximately 350 yuan per ton, with the freight cost of about 70 yuan per ton˜90 yuan per ton. As the production capacity of lithium iron material expands, ferrous sulfate crystals continue to rise in price and are difficult to buy. Therefore, the development of new, cost effective, readily available iron sources is urgently needed. Pyrite cinder is generated in very large quantities annually, reaching millions of tons, yet its recycling rate is low.

In view of this, the present invention is proposed.

### SUMMARY

In view of this, an object of the present invention is to provide a preparation method of iron phosphate and a preparation method of lithium iron phosphate.

The present invention provides a preparation method of iron phosphate, which includes the following steps:
mixing pyrite cinder and an sulfite evenly in water to obtain a first mixed system; adding phosphoric acid and a buffer to the first mixed system to perform a leaching reaction; performing a first solid-liquid separation on a slurry obtained from the leaching reaction to obtain a first filtrate and a first residue; introducing air into the first filtrate and then performing a first stirring reaction on the first filtrate; performing a second solid-liquid separation on a slurry obtained from the first stirring reaction to obtain a second filtrate and a second residue; and calcining the second residue to obtain iron phosphate;
wherein the pressure of the leaching reaction is 0.25 MPa˜0.5 MPa; the time of the leaching reaction is 1 hours˜2 hours;
the pH of the reaction system of the leaching reaction is 1.5˜3;
the buffer includes sodium dihydrogen phosphate and/or disodium hydrogen phosphate.

Optionally, the particle size of the pyrite cinder is 80 mesh˜120 mesh.

Optionally, the molar ratio of iron elements in the pyrite cinder to the sulfite, the phosphoric acid, and the buffer is 1:(0.35˜0.4):(0.25˜0.3):(1.7˜1.75).

Optionally, the phosphoric acid and the buffer are added to the first mixed system within 15 minutes˜30 minutes.

Optionally, the ratio of the volume of the air introduced into the first filtrate per hour to a molar amount of ferrous ions in the first filtrate is (8˜12) m³:(28˜32) mol.

Optionally, the temperature of the leaching reaction is 130° C.˜170° C.

Optionally, the leaching reaction is carried out under a stirring condition.

Optionally, before introducing air into the first filtrate, the first filtrate is heated to 40° C.˜60° C. under a stirring condition.

Optionally, the first stirring reaction specifically includes:
stirring the first filtrate after introduction of air until the iron content in the supernatant is less than or equal to 0.5 g/L, heating the first filtrate to 90° C.˜95° C. and continuing stirring for 30 minutes˜60 minutes.

Optionally, before calcining the second residue, the second residue is washed and dried.

Optionally, the temperature of for washing the second residue is 40° C.˜50° C.

Optionally, the washing is carried out until the pH of the liquid after wash is greater than 4.5.

Optionally, the moisture content of the dried second residue is less than 0.5%. The second residue is calcined at a temperature of 650° C.˜680° C.

Optionally, the second residue is calcined for 60 minutes˜90 minutes.

Optionally, the preparation method of iron phosphate further includes:
after the leaching reaction, introducing the gas generated from the leaching reaction into a sodium hydroxide solution to obtain sodium sulfite.

Optionally, the preparation method of iron phosphate further includes:
cooling the second filtrate and performing a third solid-liquid separation on the second filtrate to obtain sodium sulfate crystals and a mother liquor; adding sodium sulfide to the mother liquor to obtain a third filtrate and a third residue; adjusting the pH of the third filtrate to 9˜10, and performing a fourth solid-liquid separation on the third filtrate to obtain a fourth filtrate and a fourth residue; calcining the third residue, and dissolving the calcined third residue with sulfuric acid to obtain a second mixed system; performing extraction and concentration crystallization on the second mixed system to obtain crude copper sulfate and crude cobalt sulfate.

Optionally, the second filtrate is cooled to a temperature of 5° C.˜10° C.

Optionally, the third residue is calcined at a temperature of 500° C.˜700° C.

Optionally, the third residue is calcined for 2 hours to 4 hours.

Optionally, the preparation method of iron phosphate further includes:
adding aqua regia to the first residue after flotation and enrichment to obtain a third mixed system; performing a fifth solid-liquid separation on the third mixed system to obtain a fifth filtrate; performing a sixth solid-liquid separation on the fifth filtrate added with sodium chloride to obtain silver chloride and a sixth filtrate; adding iron powder to the sixth filtrate to obtain crude gold powder.

The present invention provides a preparation method of lithium iron phosphate, including the preparation method of iron phosphate described in the above technical solution.

The preparation method of lithium iron phosphate in embodiments of the present invention is simple and cost effective.

Compared to the prior art, the beneficial effects of the embodiments of the present invention are as follows:

(1) The preparation method of ferric phosphate provided by the embodiments of the present invention cleverly uses high-pressure reduction leaching to dissolve Fe₃O₄ and red iron oxide, which are commonly difficult to be dissolved in acid, wherein a mixed solution of phosphoric acid and sodium dihydrogen phosphate is used to leach the reduced iron salts to obtain a solution of ferrous dihydrogen phosphate. Moreover, as pH is relatively high, the dissolution of aluminum, calcium, magnesium, and other elements is minimized, thereby significantly improving the leaching rate of iron. The leached iron is then used in the preparation of iron phosphate.

(2) The preparation method of iron phosphate provided by the embodiments of the present invention can also recover cobalt, copper, gold, silver, sodium sulfate, etc. from pyrite cinder, greatly increasing the added value of pyrite cinder and improving the resource utilization rate of pyrite cinder.

(3) The preparation method of lithium iron phosphate provided by the embodiments of the present invention is simple and cost effective.

### BRIEF DESCRIPTION OF THE DRAWINGS

In order to more clearly describe the embodiments of the present application, the accompanying drawings to be used in the description of the embodiments or prior art will be described briefly. Obviously, the drawings described below are only for some embodiments of the present application. For ordinary skilled persons in the art, other drawings can also be obtained based on the following drawings without creative work.

FIG. 1 is a scanning electron microscopic image of iron phosphate obtained according to an embodiment of the present invention.

FIG. 2 is a scanning electron microscopic image of iron phosphate obtained according to another embodiment of the present invention.

FIG. 3 is a particle size distribution diagram of iron phosphate obtained according to yet another embodiment of the present invention.

### DETAILED DESCRIPTION

The following will clearly and completely describe the technical solutions of the present invention with reference to the drawings and the embodiments. It can be understood by the skilled in the art that the described embodiments are merely some rather than all of the embodiments of the present invention. The embodiments are for illustration only and not intended to limit the scope of the present invention. All other embodiments obtained by a person of ordinary skill in the art based on the embodiments of the present invention without making creative efforts shall fall within the protection scope of the present invention. When specific conditions are not specified in the embodiments, conventional conditions or those recommended by manufacturers are employed.

Reagents or instruments not specifying the manufacturer are conventional products available for purchase on the market.

An aspect of the present invention relates to a preparation method of iron phosphate, which includes the following steps:
mixing pyrite cinder and an sulfite evenly in water to obtain a first mixed system; adding phosphoric acid and a buffer to the first mixed system to perform a leaching reaction; performing a first solid-liquid separation on a slurry obtained from the leaching reaction to obtain a first filtrate and a first residue; introducing air into the first filtrate and then performing a first stirring reaction on the first filtrate; performing a second solid-liquid separation on a slurry obtained from the first stirring reaction to obtain a second filtrate and a second residue; and calcining the second residue to obtain iron phosphate;
wherein the pressure of the leaching reaction is 0.25 MPa˜0.5 MPa;
the pH of the reaction system of the leaching reaction is 1.5˜3;
the buffer includes sodium dihydrogen phosphate and/or disodium hydrogen phosphate.

In some specific embodiments, the pressure of the leaching reaction can be, for example, but is not limited to 0.25 MPa, 0.3 MPa, 0.35 MPa, 0.4 MPa, 0.45 MPa, or 0.5 MPa.

In some specific embodiments, the pH of the reaction system of the leaching reaction can be, for example, but is not limited to 1.5, 2, 2.5, or 3.

Pyrite cinder, also known as pyrite ash or slag, refers to a waste product obtained in sulfuric acid production using pyrite, and is a kind of chemical industry waste. Since the cinder contains iron, it can be used as a raw material in steel making. Pyrite cinder contains about 20%˜50% iron oxides (Fe₂O₃, Fe₃O₄, FeO), about 15%˜65% silicon dioxide, about 10% aluminum oxide, about 5% calcium oxide, less than 5% magnesium oxide, about 1%˜2% sulfur, and usually also contains copper, cobalt, lead, zinc, gold and silver, wherein Fe₃O₄ is formed to be dense under the passivation effect of sulfuric acid.

The preparation method of ferric phosphate provided by the embodiments of the present invention cleverly uses high-pressure reduction leaching to dissolve Fe₃O₄ and red iron oxide, which are commonly difficult to be dissolved in acid, wherein a mixed solution of phosphoric acid and sodium dihydrogen phosphate is used to leach the reduced iron salts to obtain a solution of ferrous dihydrogen phosphate. Moreover, as the pH of the reaction system of the leaching reaction is maintained at 1.5˜3, the dissolution of aluminum, calcium, magnesium, and other elements is minimized, thereby significantly improving the leaching rate of iron.

Phosphoric acid can provide hydrogen ions; sodium dihydrogen phosphate and disodium hydrogen phosphate as buffer solutions can replenish hydrogen ions after the hydrogen ions of phosphate are consumed, and can prevent the pH of the solution from becoming over low, thus avoiding the leaching of other impurities.

The leaching reaction of the present invention is carried out under specific leaching conditions, greatly improving the leaching rate. In addition, the added sulfite exhibits a reducing property in an acidic environment, thereby reducing ferric ions to divalent iron, further increasing the leaching rate, and finally yielding a ferrous dihydrogen phosphate solution. Moreover, in a weak acidic environment with abundant dihydrogen phosphate, the ferrous dihydrogen phosphate solution is generated.

Optionally, the sulfite includes sodium sulfite and/or potassium sulfite.

Optionally, the particle size of the pyrite cinder is 80 mesh˜120 mesh.

In some specific embodiments, the particle size of the pyrite cinder can be, for example, but is not limited to 80 mesh, 90 mesh, 100 mesh, 110 mesh, or 120 mesh.

Optionally, the molar ratio of iron elements in the pyrite cinder to the sulfite, the phosphoric acid, and the buffer is 1:(0.35˜0.4):(0.25˜0.3):(1.7˜1.75).

In some specific embodiments, the molar ratio of the iron elements in the pyrite cinder to the sulfite, the phosphoric acid, and the buffer can be, for example, but is not limited to 1:0.35:0.25:1.7, 1:0.37:0.28:1.173, or 1:0.4:0.3:1.75.

Optionally, the phosphoric acid and the buffer are added to the first mixed system within 15 minutes˜30 minutes (for example, 15 minutes, 20 minutes, 25 minutes, or 30 minutes).

Optionally, the ratio of the volume of the air introduced into the first filtrate per hour to a molar amount of ferrous ions in the first filtrate is (8˜12) m³:(28˜32) mol.

In some specific embodiments, the ratio of the volume of the air introduced into the first filtrate per hour to the ferrous ions in the first filtrate can be, for example, but is not limited to 8:28, 10:30, or 12:32.

Optionally, the temperature of the leaching reaction is 130° C.˜170° C.

In some specific embodiments, the temperature of the leaching reaction can be, for example, but is not limited to 130° C., 140° C., 150° C., 160° C., or 170° C.

Optionally, the leaching reaction time is 1 hour to 2 hours.

In some specific embodiments, the leaching reaction time can be, for example, but is not limited to 1 hour, 1.2 hours, 1.4 hours, 1.6 hours, 1.8 hours, or 2 hours

Optionally, the leaching reaction is carried out under a stirring condition.

Optionally, before introducing air into the first filtrate, the first filtrate is heated to 40° C.˜60° C. (for example, 40° C., 45° C., 50° C., 55° C., or 60° C.) under a stirring condition.

Optionally, the first stirring reaction specifically includes:
stirring the first filtrate after introduction of air until the iron content in the supernatant is less than or equal to 0.5 g/L, heating the first filtrate to 90° C.˜95° C. (for example, 90° C., 91° C., 92° C., 93° C., 94° C., or 95° C.) and continuing stirring for 30 minutes˜60 minutes (for example, 30 min, 35 min, 40 min, 45 min, 50 min, 55 min, or 60 min).

Optionally, before calcining the second residue, the second residue is washed and dried.

Optionally, the second residue is washed at a temperature of 40° C.˜50° C. (for example, 40° C., 42° C., 44° C., 46° C., 48° C., or 50° C.).

Optionally, the second residue is washed until the pH of the liquid after wash is greater than 4.5 (for example, 4.5, 4.8, 5, 5.5, 6, or 6.5).

Optionally, the moisture content of the dried second residue is less than 0.5% (for example, 0.1%, 0.2%, 0.3%, 0.4%, or 0.5%).

Optionally, the second residue is calcined at a temperature of 650° C.˜680° C. (for example, 650° C., 655° C., 660° C., 665° C., 670° C., 675° C., or 680° C.).

Optionally, the second residue is calcined for 60 minutes˜90 minutes (for example, 60 minutes, 65 minutes, 70 minutes, 75 minutes, 80 minutes, 85 minutes, or 90 minutes).

Optionally, the calcined second residue is then to be cooled, crushed, screened, iron removed, and vacuum packaged to obtain anhydrous iron phosphate.

Optionally, the preparation method of iron phosphate further includes:
after the leaching reaction, introducing the gas generated from the leaching reaction into a sodium hydroxide solution to obtain sodium sulfite, which is recovered for later use.

Optionally, the preparation method of iron phosphate further includes:
cooling the second filtrate and performing a third solid-liquid separation on the second filtrate to obtain sodium sulfate crystals and a mother liquor; adding sodium sulfide to the mother liquor to obtain a third filtrate and a third residue; adjusting the pH of the third filtrate to 9˜10, and performing a fourth solid-liquid separation on the third filtrate to obtain a fourth filtrate and a fourth residue; calcining the third residue, and dissolving the calcined third residue with sulfuric acid to obtain a second mixed system; performing extraction and concentration crystallization on the second mixed system to obtain crude copper sulfate and crude cobalt sulfate.

Optionally, the second filtrate is cooled to a temperature of 5° C.˜10° C. (for example, 5° C., 7° C., 8° C., 9° C., or 10° C.).

The second filtrate can be mixed with a sulfite, then mixed with sodium dihydrogen phosphate, and then returned to leach the pyrite cinder. The second filtrate after three cycles of recycling use is concentrated to a Baumé degree of 45˜50, then cooled to a temperature of 5° C.˜10° C., centrifuged and dried to obtain sodium sulfate crystals.

The fourth filtrate is added with phosphoric acid and sodium dihydrogen phosphate, and then is returned to leach the pyrite cinder.

Optionally, the third residue is calcined at a temperature of 500° C.˜700° C. (for example, 530° C., 560° C., 590° C., 620° C., 650° C., 680° C., or 700° C.).

Optionally, the third residue is calcined for 2 hours to 4 hours (for example, 2 hours, 2.5 hours, 3 hours, 3.5 hours, or 4 hours).

The waste gas generated in calcining the third residue is absorbed by a sodium hydroxide solution, which is then returned to leach the pyrite cinder.

Optionally, the preparation method of iron phosphate further includes:
adding aqua regia to the first residue after flotation and enrichment to obtain a third mixed system; performing a fifth solid-liquid separation on the third mixed system to obtain a fifth filtrate; performing a sixth solid-liquid separation on the fifth filtrate added with sodium chloride to obtain silver chloride and a sixth filtrate; adding iron powder to the sixth filtrate to obtain crude gold powder.

The present invention not only uses the iron source in the pyrite cinder to prepare iron phosphate, but also enriches the copper and cobalt from the pyrite cinder to obtain crude copper sulfate and crude cobalt sulfate, and can also enrich silver and gold from the pyrite cinder.

Another aspect of the present invention relates to a preparation method of lithium iron phosphate, including the preparation method of iron phosphate.

The preparation method of lithium iron phosphate is as follows:

The above-mentioned anhydrous iron phosphate is added with a lithium source, a carbon source, and a dopant, and then added with purified water to form a slurry. The slurry is nano-ground and then spray-dried to obtain a spray-dried material, which is then calcined in an inert atmosphere to obtain a calcined material. The calcined material is subjected to crushing, screening, iron removal and vacuum packaging to obtain lithium iron phosphate.

The mass ratio of the anhydrous iron phosphate, the lithium source, the carbon source, and the dopant is 1:(0.2˜0.25):(0.1˜0.2):(0.0005˜0.005). The lithium source is lithium carbonate or lithium hydroxide. The carbon source is at least one of glucose, sucrose, soluble starch, PEG, citric acid, ascorbic acid, or benzoic acid. The dopant is at least one of a titanium compound, a vanadium compound, a magnesium compound, or a manganese compound.

In nano-grinding, the slurry is ground until the particle size thereof reaches 100 nm˜600 nm; the inert atmosphere is nitrogen gas, the calcining temperature is 600° C.˜900° C., and the calcining time is 5 hours˜40 hours.

The preparation method of lithium iron phosphate is simple and cost effective.

In order to further illustrate the present invention, the preparation method of iron phosphate and the preparation method of lithium iron phosphate provided by the present invention are described in detail below with reference to examples, but the examples should not be understood as limiting the scope of the present invention.

### Example 1

The preparation method of iron phosphate provided in this example includes the following steps:

(1) The pyrite cinder is ground in a ball mill and sieved through a 100-mesh sieve. The test data of the pyrite cinder samples are shown in Table 1.

TABLE 1
Specific information of pyrite cinder

| Index | Fe₂O₃ | Fe₃O₄ | FeO | Si | Al |
|---|---|---|---|---|---|
| Data | 16.2% | 52.5% | 1.9% | 10.5% | 3.7% |
| Ca | Mg | S | Cu | Co | Zn |
| 2.7% | 3.1% | 1.2% | 0.21% | 0.11% | 0.0078% |
| Au | Ag | Pb | Ni | Cr | cd |
| 2.1 g/ton | 21.7 g/ton | 0.0112% | 0.0039% | 0.0078% | 0.0002% |

(2) The pyrite cinder is introduced into an autoclave, added with a sodium sulfite solution, mixed and stirred. A mixed solution of phosphoric acid and sodium dihydrogen phosphate is added into the autoclave through a high-pressure pump, while raising the temperature to 150° C., so that the pressure in the autoclave reaches 0.42 MPa. The addition of the mixed solution of phosphoric acid and sodium dihydrogen phosphate lasts for 20 minutes. The stirring reaction at this temperature and pressure is carried out for 1.5 hours. The slurry is filtered after the reaction to obtain a first filtrate and a first residue. A sample of the first residue is taken to obtain the test data as shown in Table 2.

TABLE 2
Specific information of the first residue in Example 1

| Index | Fe | Au | Ag | Si | Al |
|---|---|---|---|---|---|
| Data | 1.2% | 6.8 g/ton | 67.4 g/ton | 31.3% | 2.1% |

| Ca | Mg | S | Cu | Co | Zn |
|---|---|---|---|---|---|
| 1.3% | 1.1% | 1.8% | 0.003% | 0.002% | 0.001% |

| Pb | Ni | Cr | cd |
|---|---|---|---|
| 0.008% | 0.002% | 0.003% | 0.0002% |

The leaching rate of iron is higher than 95%, and the first residue is enriched with elements such as gold and silver.

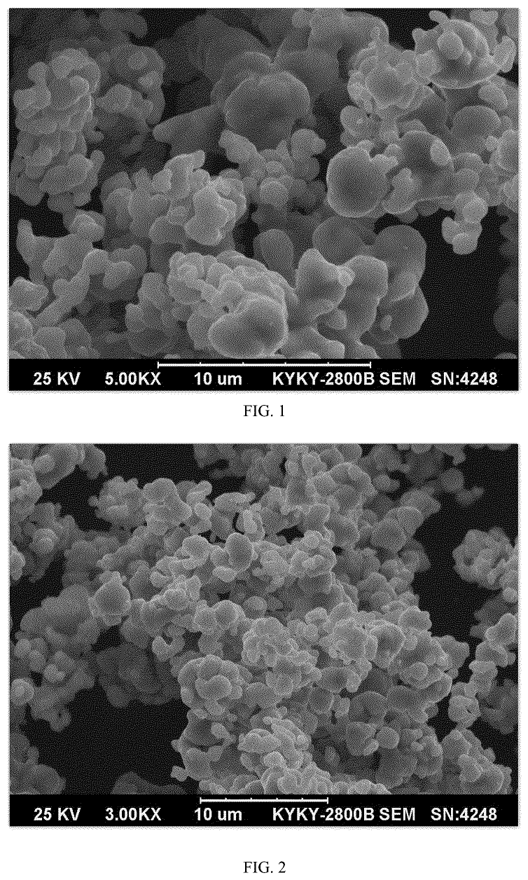

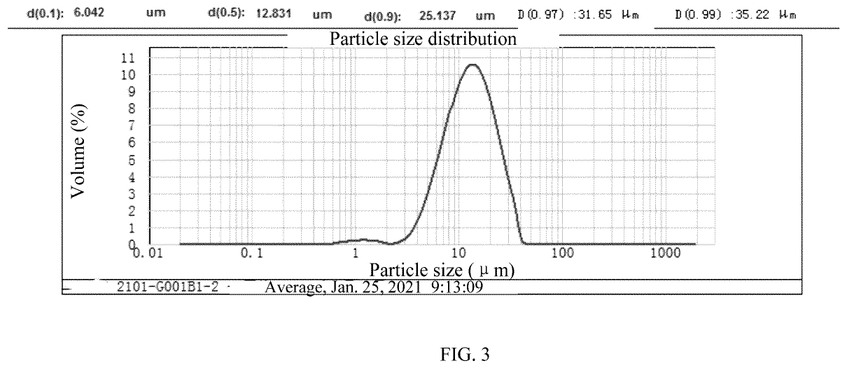

(3) The first filtrate is heated with stirring to 50° C., and then air is introduced. Under these conditions, the first filtrate is reacted with stirring until the concentration of iron in the supernatant reaches 0.35 g/L. Then the first filtrate is heated to 95° C., and reacted with stirring at this temperature for 40 minutes, and then filtered to obtain a second filtrate and a second residue. The second residue is washed, dried, and calcined. The calcining is performed in a rotary kiln, the calcining temperature is 670° C., and the calcining time is 80 minutes. The calcined material is cooled, crushed, screened, iron removed, and vacuum packed to obtain anhydrous iron phosphate. The test data of the anhydrous iron phosphate are shown in Table 3. The scanning electron microscopic images of the iron phosphate are shown in FIGS. 1 and 2. The particle size distribution of the iron phosphate is shown in the FIG. 3.

TABLE 3
Specific information of anhydrous iron phosphate

| | | | molar ratio | | |
|---|---|---|---|---|---|
| Index | Fe | P | of Fe:P | Si | Al |
| Data | 36.09% | 20.66% | 0.9688 | 7.9 ppm | 21.5 ppm |
| Ca | Mg | S | Cu | Co | Zn |
| 29.5 ppm | 25.9 ppm | 21.5 ppm | 0.3 ppm | 10.4 ppm | 19.4 ppm |
| BET | D50 | Pb | Ni | Cr | cd |
| 4.5 m²/g | 12.831 μm | 1.6 ppm | 1.9 ppm | 2.9 ppm | 5.9 ppm |

(4) The second filtrate is returned to mix with sodium dihydrogen phosphate, and then returned to leach the pyrite cinder. After three cycles of recycling use of the second filtrate, the second filtrate is concentrated to have a Baumé degree of 48, then cooled to 8° C., and centrifuged to dry, thereby obtaining sodium sulfate crystals. The mother liquor after the crystallization is added with a sodium sulfide solution and filtered to obtain a third filtrate and a third residue. The pH of the third filtrate is adjusted to 9.5 by adding sodium hydroxide, and the third filtrate is filtered to obtain a fourth filtrate and a fourth residue. The fourth filtrate is returned and used with a fresh phosphoric acid solution and sodium dihydrogen phosphate. The purity of the obtained sodium sulfate crystals is greater than or equal to 98.5%.

The molar ratio of iron in the pyrite cinder to sodium sulfite, phosphoric acid, and sodium dihydrogen phosphate is 1:0.37:0.3:1.7, the concentration of the sodium sulfite solution is 2.5 mol/L, and a total molar concentration of phosphoric acid and sodium dihydrogen phosphate in the mixed solution is 2 mol/L.

(5) The third residue is calcined in a rotary kiln. The calcining temperature is 600° C., and the calcining time is 3 hours. The waste gas generated in calcining the third residue is absorbed by a sodium hydroxide solution, which is then returned to leach the pyrite cinder. The calcined third residue is dissolved in sulfuric acid, and cobalt and copper are extracted with a P204 extraction agent to obtain a cobalt-copper solution, which is concentrated and crystallized to obtain crude copper sulfate with a purity of 95.6% and crude cobalt sulfate with a purity of 91.5%.

(6) After flotation and further enrichment of gold and silver, the first residue is dissolved in aqua regia and filtered. The obtained filtrate is added with sodium chloride to precipitate the silver therein, obtaining silver chloride. Iron powder is added to the remaining filtrate to displace gold, resulting in crude gold powder.

(7) The gas generated in the autoclave is introduced into a 2 mol/L sodium hydroxide solution, while introducing nitrogen gas into the autoclave, so that the sulfur dioxide gas is discharged and absorbed by the sodium hydroxide solution. The concentration of sodium hydroxide in the gas absorbed solution is finally lower than 0.2 mol/L, and the obtained gas absorbed solution is a sodium sulfite solution, which can be returned for recycling use. The ratio of the flow rate per hour (m³) of the introduced air to the molar amount (mol) of ferrous ions in the solution is 20.

The preparation method of lithium iron phosphate is as follows:

The above-mentioned anhydrous iron phosphate is added with a lithium source, a carbon source, and a dopant, and then added with purified water to form a slurry. The slurry is nano-ground and then spray-dried to obtain a spray-dried material, which is then calcined in an inert atmosphere to obtain a calcined material. The calcined material is subjected to crushing, screening, iron removal and vacuum packaging to obtain lithium iron phosphate.

The mass ratio of the anhydrous iron phosphate, the lithium source, the carbon source, and the dopant is 1:0.23:0.13:0.0015. The lithium source is lithium carbonate. The carbon source is glucose. The dopant is titanium dioxide.

In the nano-grinding, the slurry is ground until the particle size thereof reaches 320 nm; the inert atmosphere is nitrogen gas, the calcining temperature is 780° C., and the calcining time is 12 hours.

The final test data of lithium iron phosphate is as follows:

| Index | Li | Fe | P | C |
|---|---|---|---|---|
| Data | 4.52% | 36.84% | 19.45% | 1.45% |
| Electrical | Compaction | 0.1 C first | 0.1 C first | First |
| resistivity of | density | charge | discharge | discharge |
| powder | | capacity | capacity | efficiency |
| 13.6Ω · cm | 2.42 g/mL | 162.5 mAh/g | 156.8 mAh/g | 96.5% |

The powder electrical resistivity is measured using the four-probe method with a pressure of 10 MPa.

The pressure used for testing the compaction density is 3T.

### Example 2

The preparation method of iron phosphate provided in this example includes the following steps:

(1) is the same as in Example 1.

(2) The pyrite cinder is introduced into an autoclave, added with a potassium sulfite solution, mixed and stirred. A mixed solution of phosphoric acid and sodium dihydrogen phosphate is added into the autoclave through a high-pressure pump, while raising the temperature to 130° C., so that the pressure in the autoclave reaches 0.5 MPa. The addition of the mixed solution of phosphoric acid and sodium dihydrogen phosphate lasts for 15 minutes. The stirring reaction at this temperature and pressure is carried out for 2 hours. The slurry is filtered after the reaction to obtain a first filtrate and a first residue.

(3) The first filtrate is heated with stirring to 40° C., and then air is introduced. Under these conditions, the first filtrate is reacted with stirring until the concentration of iron in the supernatant reaches 0.1 g/L. Then the first filtrate is heated to 95° C., and reacted with stirring at this temperature for 30 minutes, and then filtered to obtain a second filtrate and a second residue. The second residue is washed, dried, and calcined. The calcining is performed in a rotary kiln, the calcining temperature is 680° C., and the calcining time is 60 minutes. The calcined material is cooled, crushed, screened, iron removed, and vacuum packed to obtain anhydrous iron phosphate.

(4) The second filtrate is returned to mix with sodium dihydrogen phosphate, and then returned to leach the pyrite cinder. After three cycles of recycling use of the second filtrate, the second filtrate is concentrated to have a Baumé degree of 48, then cooled to 8° C., and centrifuged to dry, thereby obtaining sodium sulfate crystals. The mother liquor after the crystallization is added with a sodium sulfide solution and filtered to obtain a third filtrate and a third residue. The pH of the third filtrate is adjusted to 9 by adding sodium hydroxide, and the third filtrate is filtered to obtain a fourth filtrate and a fourth residue. The fourth filtrate is returned and used with a fresh phosphoric acid solution and sodium dihydrogen phosphate.

The molar ratio of iron in the pyrite cinder to potassium sulfite, phosphoric acid, and sodium dihydrogen phosphate is 1:0.35:0.25:1.7, the concentration of the potassium sulfite solution is 2.5 mol/L, and a total molar concentration of phosphoric acid and sodium dihydrogen phosphate in the mixed solution is 2 mol/L.

(5) The third residue is calcined in a rotary kiln. The calcining temperature is 500° C., and the calcining time is 4 hours. The waste gas generated in calcining the third residue is absorbed by a sodium hydroxide solution, which is then returned to leach the pyrite cinder. The calcined third residue is dissolved in sulfuric acid, and cobalt and copper are extracted with a P204 extraction agent to obtain a cobalt-copper solution, which is concentrated and crystallized to obtain crude copper sulfate and crude cobalt sulfate.

(6)˜(7) are the same as in Example 1.

### Example 3

The preparation method of iron phosphate provided in this example includes the following steps:

(1) is the same as in Example 1.

(2) The pyrite cinder is introduced into an autoclave, added with a sodium sulfite solution, mixed and stirred. A mixed solution of phosphoric acid and sodium dihydrogen phosphate is added into the autoclave through a high-pressure pump, while raising the temperature to 170° C., so that the pressure in the autoclave reaches 0.25 MPa. The addition of the mixed solution of phosphoric acid and sodium dihydrogen phosphate lasts for 30 minutes. The stirring reaction at this temperature and pressure is carried out for 1 hour. The slurry is filtered after the reaction to obtain a first filtrate and a first residue.

(3) The first filtrate is heated with stirring to 60° C., and then air is introduced. Under these conditions, the first filtrate is reacted with stirring until the concentration of iron in the supernatant reaches 0.5 g/L. Then the first filtrate is heated to 90° C., and reacted with stirring at this temperature for 60 minutes, and then filtered to obtain a second filtrate and a second residue. The second residue is washed, dried, and calcined. The calcining is performed in a rotary kiln, the calcining temperature is 650° C., and the calcining time is 90 minutes. The calcined material is cooled, crushed, screened, iron removed, and vacuum packed to obtain anhydrous iron phosphate.

(4) The second filtrate is returned to mix with sodium dihydrogen phosphate, and then returned to leach the pyrite cinder. After three cycles of recycling use of the second filtrate, the second filtrate is concentrated to have a Baumé degree of 48, then cooled to 8° C., and centrifuged to dry, thereby obtaining sodium sulfate crystals. The mother liquor after the crystallization is added with a sodium sulfide solution and filtered to obtain a third filtrate and a third residue. The pH of the third filtrate is adjusted to 10 by adding sodium hydroxide, and the third filtrate is filtered to obtain a fourth filtrate and a fourth residue. The fourth filtrate is returned and used with a fresh phosphoric acid solution and sodium dihydrogen phosphate.

The molar ratio of iron in the pyrite cinder to sodium sulfite, phosphoric acid, and sodium dihydrogen phosphate is 1:0.4:0.3:1.75, the concentration of the sodium sulfite solution is 2.5 mol/L, and a total molar concentration of phosphoric acid and sodium dihydrogen phosphate in the mixed solution is 2 mol/L.

(5) The third residue is calcined in a rotary kiln. The calcining temperature is 700° C., and the calcining time is 2 hours. The waste gas generated in calcining the third residue is absorbed by a sodium hydroxide solution, which is then returned to leach the pyrite cinder. The calcined third residue is dissolved in sulfuric acid, and cobalt and copper are extracted with a P204 extraction agent to obtain a cobalt-copper solution, which is concentrated and crystallized to obtain crude copper sulfate and crude cobalt sulfate.

(6)˜(7) are the same as in Example 1.

### Comparative Example 1

The preparation method of iron phosphate provided in this comparative example is different from Example 1 only in that the pressure of the leaching reaction is 0.1 MPa, and the leaching rate of iron is 83%.

### Comparative Example 2

The preparation method of iron phosphate provided in this comparative example is different from Example 1 only in that the pH of the reaction system of the leaching reaction is 1. The specific information of the first residue is shown in Table 4.

TABLE 4
Specific information of the first residue in Comparative Example 2

| Index | Fe | Au | Ag | Si | Al |
|---|---|---|---|---|---|
| Data | 1.12% | 6.8 g/ton | 67.3 g/ton | 30.1% | 1.8% |

| Ca | Mg | S | Cu | Co | Zn |
|---|---|---|---|---|---|
| 0.8% | 0.9% | 1.6% | 0.002% | 0.001% | 0.001% |

| Pb | Ni | Cr | cd |
|---|---|---|---|
| 0.005% | 0.001% | 0.001% | 0.0001% |

### Comparative Example 3

The preparation method of iron phosphate provided in this comparative example is different from Example 1 only in that the time of the leaching reaction is 0.5 hours, and the leaching rate of iron is 81%.

By comparing Example 1, Comparative Example 1, and Comparative Example 3, it can be seen that the pressure and time of the leaching reaction need to be within the specified ranges to ensure the leaching effect of iron.

By comparing Example 1 and Comparative Example 2, it can be seen that at low pH, the leaching rate of impurities is greatly increased, resulting in the introduction of various impurities into the iron solution, affecting the leaching effect of iron, indicating that the pH needs to be within the specified range to ensure the leaching purity of iron.

Although the present invention has been illustrated and described with specific embodiments, it should be realized that the above embodiments are only used to illustrate rather than limit the technical solutions of the present invention. Those of ordinary skill in the art should understand that without departing from the spirit and scope of the present invention, the technical solutions described in the foregoing embodiments can be modified, or some or all of the technical features thereof can be equivalently substituted. These modifications or substitutions shall not make the corresponding technical solutions essentially depart from the scope of the technical solutions of the various embodiments of the present invention. Therefore, such substitutions and modifications falling within the scope of the present invention are all covered by the appended claims.

The above are only embodiments of the present invention. It should be noted that those skilled in the art can make several improvements and modifications without departing from the principles of the present invention. These improvements and modifications should be regarded as within the protection scope of the present invention.

1-10. (canceled)

11. A preparation method of iron phosphate, comprising:
mixing pyrite cinder and a sulfite evenly in water to obtain a first mixed system;
adding phosphoric acid and a buffer to the first mixed system to perform a leaching reaction;
performing a first solid-liquid separation on a slurry obtained from the leaching reaction to obtain a first filtrate and a first residue;
introducing air into the first filtrate and then performing a first stirring reaction on the first filtrate;
performing a second solid-liquid separation on a slurry obtained from the first stirring reaction to obtain a second filtrate and a second residue; and
calcining the second residue to obtain iron phosphate;
wherein the leaching reaction is performed at a pressure of 0.25 MPa˜0.5 MPa for a time of 1 hour˜2 hours; a pH of a reaction system of the leaching reaction is 1.5˜3; the buffer comprises sodium dihydrogen phosphate and/or disodium hydrogen phosphate.

12. The preparation method according to claim 11, wherein a particle size of the pyrite cinder is 80 mesh˜120 mesh.

13. The preparation method according to claim 11, wherein a molar ratio of iron elements in the pyrite cinder to the sulfite, the phosphoric acid, and the buffer is 1:(0.35˜0.4):(0.25˜0.3):(1.7˜1.75).

14. The preparation method according to claim 11, wherein the phosphoric acid and the buffer are added to the first mixed system within 15 minutes˜30 minutes.

15. The preparation method according to claim 11, wherein a ratio of a volume of the air introduced into the first filtrate per hour to a molar amount of ferrous ions in the first filtrate is (8˜12) m³:(28˜32) mol.

16. The preparation method according to claim 11, wherein the leaching reaction is performed at a temperature of 130° C.˜170° C.

17. The preparation method according to claim 16, wherein the leaching reaction is performed under a stirring condition.

18. The preparation method according to claim 11, wherein, before introducing air into the first filtrate, the preparation method further comprises heating the first filtrate to 40° C.˜60° C. under a stirring condition.

19. The preparation method according to claim 18, wherein the first stirring reaction specifically comprises:
stirring the first filtrate after introduction of air until the iron content in supernatant is less than or equal to 0.5 g/L; heating the first filtrate to 90° C.˜95° C. and continuing stirring for 30 minutes˜60 minutes.

20. The preparation method according to claim 11, wherein, before calcining the second residue, the preparation method further comprises washing and drying the second residue.

21. The preparation method according to claim 20, wherein a temperature for washing the second residue is 40° C.˜50° C.

22. The preparation method according to claim 20, wherein washing is carried out until pH of liquid after wash is greater than 4.5.

23. The preparation method according to claim 20, wherein a moisture content of the second residue after drying is less than 0.5%.

24. The preparation method according to claim 11, wherein the second residue is calcined at a temperature of 650° C.˜680° C.

25. The preparation method according to claim 24, wherein the second residue is calcined for 60 minutes˜90 minutes.

26. The preparation method according to claim 11, wherein the preparation method further comprises:
after the leaching reaction, introducing gas generated from the leaching reaction into a sodium hydroxide solution to obtain sodium sulfite.

27. The preparation method according to claim 11, wherein the preparation method further comprises:
cooling the second filtrate and performing a third solid-liquid separation on the second filtrate to obtain sodium sulfate crystals and a mother liquor;
adding sodium sulfide to the mother liquor to obtain a third filtrate and a third residue;
adjusting pH of the third filtrate to 9˜10, and performing a fourth solid-liquid separation on the third filtrate to obtain a fourth filtrate and a fourth residue;
calcining the third residue, and dissolving the calcined third residue with sulfuric acid to obtain a second mixed system; and
performing extraction and concentration crystallization on the second mixed system to obtain crude copper sulfate and crude cobalt sulfate.

28. The preparation method according to claim 27, wherein the second filtrate is cooled to a temperature of 5° C.˜10° C.;
the third residue is calcined at a temperature of 500° C.˜700° C.;
the third residue is calcined for 2 hours to 4 hours.

29. The preparation method according to claim 11, wherein the preparation method further comprises:
adding aqua regia to the first residue after flotation and enrichment to obtain a third mixed system;
performing a fifth solid-liquid separation on the third mixed system to obtain a fifth filtrate;
performing a sixth solid-liquid separation on the fifth filtrate added with sodium chloride to obtain silver chloride and a sixth filtrate; and
adding iron powder to the sixth filtrate to obtain crude gold powder.

30. A preparation method of lithium iron phosphate, comprising the preparation method of iron phosphate according to claim 11.
